(19) United States
(12) Patent Application Publication
(10) Pub. No.: US 2006/0082509 A1
(43) Pub. Date: Apr. 20, 2006

(54) Pad having recessive antenna

(75) Inventors: Chien-Hsin Lee, Taipei City (TW); Chia-Chi Liu, Taipei City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: TATUNG CO., LTD., Taipei City (TW)

(21) Appl. No.: 11/052,164

(22) Filed: Feb. 8, 2005

(30) Foreign Application Priority Data
Oct. 14, 2004 (TW) 093131144

(51) Int. Cl. H01Q 1/24

(52) U.S. Cl. 343/702

(57) ABSTRACT

The present invention relates to a pad having a recessive antenna and being mounted in an electronic device, comprises a pad mounted on a base plate of the electronic device and an antenna configured inside the pad. By the aforesaid structure, the electronic devices having wireless connectivity, such as multimedia computers, notebooks, or CD/DVD players, would then have more space for other functional design as well as easier assembly of the antenna.

### BACKGROUND OF THE INVENTION

1. Field of the Invention

The present invention relates to a pad having a recessive antenna, and more particular, to a pad of an electronic device having wireless connecting ability, for example, multimedia computer, notebooks, or CD/DVD-players.

2. Description of Related Art

Currently, wireless access to an Internet has become a main feature of electronic devices, such as a multimedia computer with a wireless LAN card.

Taking the multimedia computer having a wireless LAN card as an example, an antenna for transmitting and receiving wireless signals is required. The conventional assembly of the antenna is directly screw-fastened to the front space of the case of the multimedia computer, then a front panel being covered on the case.

However, the increasing functions of a multimedia computer and the evolving user preferences have led to the increase of the number of the control buttons on the front panel, thereby reducing the available space on the front panel, and thus making it more difficult to setup the antenna in the front space of the case.

Therefore, it is desirable to provide an improved antenna assembly to obviate the aforementioned problems.

### SUMMARY OF THE INVENTION

The present invention relates to a pad having a recessive antenna and being mounted in an electronic device, comprising a pad and an antenna. The pad mounted on a base plate of the electronic device. The antenna configured inside the pad. The antenna for wireless connection is received in the pad according to the present invention, so as to provide additional space for other configuration possibilities and also the ease of assembling the antenna.

The abovementioned pad can be fastened to the base plate of the electronic device by screw-fasten, or by adhesive, or by hook, or by other mechanical joining means.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view of a preferred embodiment according to the present invention.

FIG. 2 is an exploded view of a preferred embodiment according to the present invention.

FIG. 3 is a perspective view of a preferred embodiment according to the present invention.

### DETAILED DESCRIPTION OF THE PREFERRED EMBODIMENT

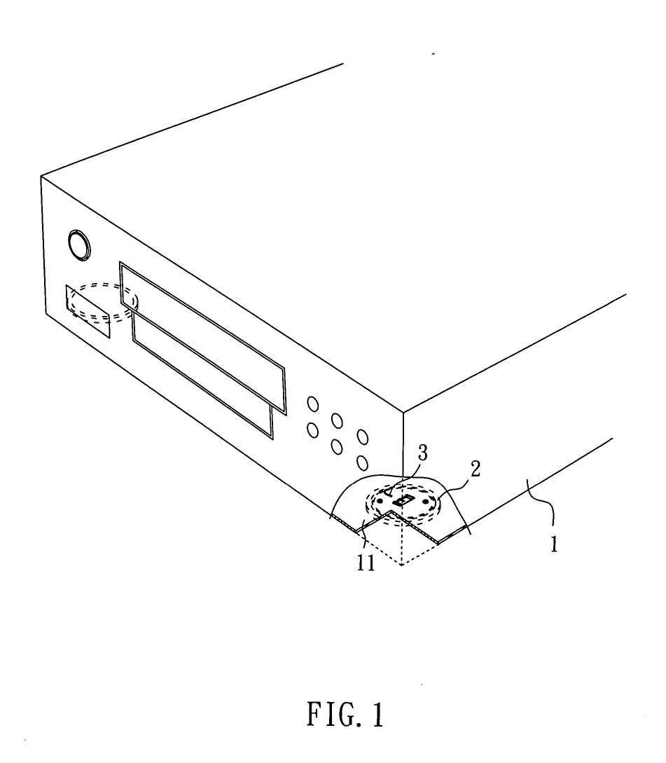

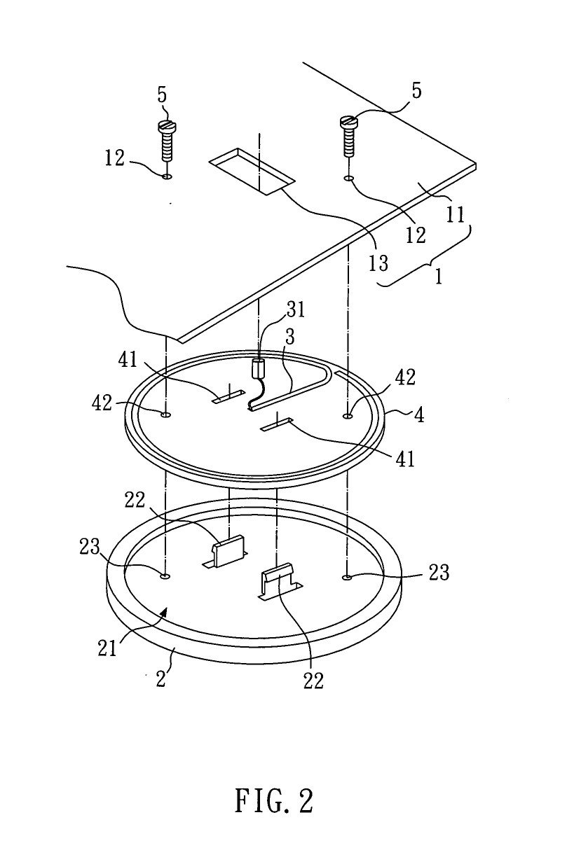

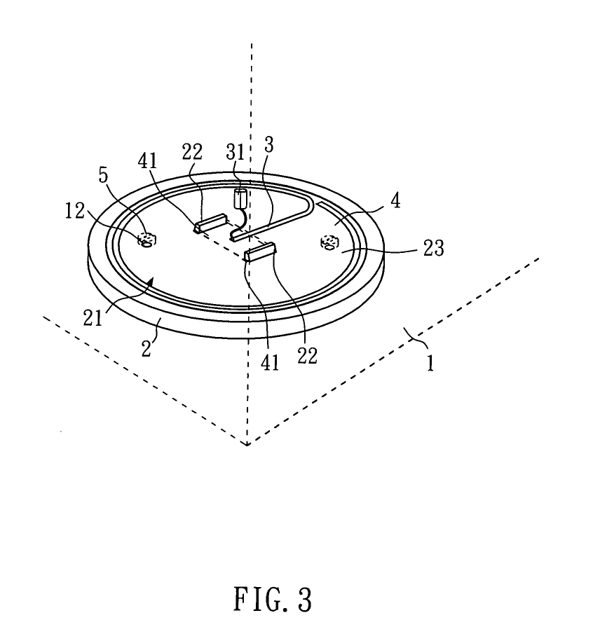

With reference to FIG. 1, FIG. 2, and FIG. 3, a pad 2 and an antenna 3 are configured to a base plate 11 of an electronic device 1 (as shown in FIG. 1). The electronic device 1 according to this embodiment is, but not limited to, a multimedia computer. The base plate 11 forms an assembling hole 13 and two penetrating holes 12 thereon (as shown in FIG. 2). The pad 2 is configured to the bottom face of the base plate 11. The antenna 3 is received inside the pad 2. As shown in the figures, a connector 31 extended from an end of the antenna 3 is electrically connected to the interior circuit board inside the electronic device 1 through the assembling hole 13 of the base plate 11.

With reference to FIG. 2, an inner chamber 21 is downwardly formed inside the pad 2, and a flat panel 4 is positioned inside the inner chamber 21 of the pad 2. Two slots 41 and two openings 42 are formed on the flat panel 4. In this preferred embodiment, the antenna 3 is coiledly laid on the flat panel 4, and preferably the flat panel 4 is a circuit board and the antenna 3 is the layout circuit on the circuit board. Additionally, the pad 2 can be manufactured by jet-molding and thus the antenna 3 being contained inside. On the other hand, two latches 22 are formed upwardly at the center of the pad 2 corresponding to the two slots 41 respectively. To assemble the pad 2 to the base plate 11, the pad 2 first joins to the flat panel 4 with the two latches 22 passing through the two lots 41 respectively and finally clip on the two sides of the assembling hole 13 of the base plate 11, to make the pad 2 and the flat panel 4 joined and secured as one together and let the pad 2 mount on the base plate 11. Two screws 5 are then respectively passed through the two penetrating holes 12 of the base plate 11, the two opening 42 of the flat panel 4 and then screw-fastened into two screw holes 23 of the pad 2.

Additionally, using the two latches 22 of the pad 2 directly passing through the two slots 41 of the flat panel 4 and then clipping onto the two sides of the assembling hole 13 of the base plate 11 of the electronic device 1 (as shown in FIG. 3) can avoid the use of screws, thus saving the labor hour. Alternatively, the pad 2 having a recessive antenna can be adhered to the base plate 11 of the electronic device 1, thereby reducing the number of components, and therefore lowers the manufacturing cost.

The abovementioned electronic device 1 can be, but not limited to, a multimedia computer, a CD/DVD player, a notebook or an electronic appliance having wireless connectivity, or other electronic devices having a wireless receiving/transmitting antenna.

The pad 2 according to the present invention having a recessive antenna 3 allows the antenna 3 to be mounted elsewhere other than on the front panel or inside the case, and thus provides additional space for other functional design as well as the ease of assembling the antenna 3.

Although the present invention has been explained in relation to its preferred embodiment, it is to be understood that many other possible modifications and variations can be made without departing from the spirit and scope of the invention as hereinafter claimed.

What is claimed is:

1. A pad having a recessive antenna and being mounted in an electronic device, comprising:
a pad mounted on a base plate of said electronic device; and
an antenna configured inside said pad.

2. The pad as claimed in claim 1, wherein said pad recessed an inner chamber for receiving said antenna therein.

3. The pad as claimed in claim 1, wherein said pad further comprises a flat panel positioned inside said inner chamber, said antenna is fastened on said flat panel.

4. The pad as claimed in claim 3, wherein said flat panel further comprises two slots and two openings, said pad further comprises two latches corresponding to hook onto the two slots of said flat panel respectively.

5. The pad as claimed in claim 1, wherein the base plate of said electronic device further comprises two penetrating holes, said pad further comprises two screw holes corresponding to the two penetrating holes of said electronic device respectively, said pad is secured to said base plate by two screws passing through said two penetrating holes and screwed into said two screw holes respectively.

6. The pad as claimed in claim 1, wherein the base plate of said electronic device further comprises an assembling hole, said antenna comprises one end and a connector fastened to said end and reaching to the interior of said electronic device through said assembling hole.
